(19) United States
(12) Patent Application Publication
(10) Pub. No.: US 2025/0116862 A1
(43) Pub. Date: Apr. 10, 2025

(54) COMPACT AND LARGE FIELD-OF-VIEW ANGLE HEAD-UP DISPLAY SYSTEM

(71) Applicant: SHENZHEN PHOTONIC CRYSTAL TECHNOLOGY CO., LTD, SHENZHEN (CN)

(72) Inventors: YONGJING WANG, SHENZHEN (CN); WEIMIN JIANG, SHENZHEN (CN); XIYU ZHANG, SHENZHEN (CN); YUHUA WANG, SHENZHEN (CN); GANG ZHENG, SHENZHEN (CN)

(21) Appl. No.: 18/985,060

(22) Filed: Dec. 18, 2024

Related U.S. Application Data
(63) Continuation of application No. PCT/CN2022/101271, filed on Jun. 24, 2022.

(51) Int. Cl. G02B 27/01

(52) U.S. Cl. CPC G02B 27/0103; G02B 2027/0123; G02B 2027/013; G02B 2027/0196

(57) ABSTRACT

A compact, wide-field-of-view head-up display system, comprising: 1) A micro-display chip; 2) A transparent optical element positioned at a certain distance from the display chip. The optical element further includes a phase modulation layer, a semi-reflective/transparent layer, and a phase compensation layer. The phase modulation layer controls the light from the micro-display chip in a specific way, such that the light forms a virtual image at a distance. The phase modulation surface can be a multilayer holographic structure or a Fresnel lens. The surface profile of the Fresnel lens can be derived from a sphere, an aspheric surface, a freeform surface, or a hologram. The phase compensation layer compensates for the phase variations from the phase modulation layer, making the light passing through the transparent element appear transparent.

### CROSS REFERENCE TO RELATED APPLICATION

This application is a continuation of International Patent Application No. PCT/CN2022/101271 with a filing date of Jun. 24, 2022, designating the United States, now pending. The content of the aforementioned applications, including any intervening amendments thereto, are incorporated herein by reference.

### TECHNICAL FIELD

The present invention belongs to the field of optical display technology, particularly relating to a compact, large field-of-view head-up display system.

### BACKGROUND TECHNOLOGY

Head-up displays (HUD) have been widely used in automobiles, ships, airplanes, and other fields. The characteristic feature of HUD is that it overlays the displayed content onto the external world, allowing the driver to simultaneously see the road conditions and the displayed information while driving. The driver does not need to look down at the display, greatly improving driving safety and comfort.

Currently, the main implementation of automotive HUDs involves high-brightness micro-displays and several traditional lenses or mirrors. In existing HUD systems, all these optical components need to be installed beneath the vehicle's dashboard. To achieve a large field of view (FOV), the final lens requires a relatively large aperture, which results in a bulky HUD system. The large volume limits the application of HUDs, and they are typically only used in a few high-end, large vehicles.

There is an urgent need for a head-up display system that is simple in structure, small in size, and low in cost.

### INVENTION CONTENT

In view of the deficiencies in the existing technologies, the object of the present invention is to provide a new compact, large field-of-view head-up display system.

The head-up display system disclosed in the present invention includes: 1) a micro display chip; and 2) a transparent optical element positioned at a certain distance from the display chip. The optical element further includes a semi-reflective, semi-transmissive layer, a phase modulation layer, and a phase compensation layer. The phase modulation layer controls the light from the micro display chip, reflecting it to the human eye, such that the light forms a virtual image at a distance. The semi-reflective, semi-transmissive layer also allows part of the real-world light to pass through. The displayed content is superimposed onto the real world without affecting the driver's normal driving.

One implementation of the solution is: The semi-reflective, semi-transmissive layer is arranged on the phase modulation layer. The light emitted from the micro display chip directly enters the semi-reflective, semi-transmissive layer, or enters the layer through light from the auxiliary optical imaging system. After being reflected by the semi-reflective, semi-transmissive layer, the light undergoes a specific phase modulation. On one hand, the light is reflected into the human eye; on the other hand, the phase modulation generates a virtual image positioned opposite to the optical element relative to the human eye. The phase compensation layer compensates for the phase changes of the phase modulation layer, ensuring that the light passing through the optical element enters the human eye without any phase modulation effect, thus entering the eye without interference.

The compact, large field-of-view head-up display system may also include: 3) an auxiliary optical imaging system located between the micro display chip and the transparent optical element.

The micro display chip may be based on commonly used micro-display technologies such as LCOS, LCD, DLP, OLED, Micro-LED, etc. This micro display chip generates a high-brightness, small-sized display image. In LCOS, LCD, DLP, and other display technologies, the micro display chip also includes an associated light source illumination module. In LED, Micro-LED, OLED, and other self-emissive display chips, the light source illumination module can be omitted to achieve a smaller volume.

The optical element further includes a phase modulation layer, a semi-reflective, semi-transmissive layer, and a phase compensation layer. The phase modulation layer, in conjunction with the semi-reflective, semi-transmissive layer, performs specific control on the light emitted from the micro display chip and passing through the auxiliary optical imaging system, reflecting it into the human eye so that the light forms a virtual image at a distance. The semi-reflective, semi-transmissive layer allows part of the real-world light to pass through. Therefore, a virtual display is superimposed onto the real world without affecting the driver's normal driving.

In the first embodiment of the present invention, the phase modulation surface is a holographic structure. This holographic structure can be generated using computational holography methods or by the coherent recording method with two laser beams. The design requirement for this holographic structure is to form a virtual image of the micro display chip through the holographic structure.

In another embodiment of the present invention, the phase modulation surface can be a Fresnel lens. A Fresnel lens retains the surface shape of a traditional lens, removing the parallel flat parts of the lens that do not affect the light, transforming a thick lens into a thin plate, while still preserving the original functionality of the lens. The surface shape of the Fresnel lens can be derived from a spherical, aspherical, or freeform surface, or even from a hologram. During the design process, optical simulation software is used to design spherical, aspherical, and freeform surfaces, and then, using methods known to optical engineers in the field, these curved surfaces with specific curvature heights are formed into the shape of a Fresnel lens. The phase modulation surface is also coated with a semi-reflective, semi-transmissive layer. The light emitted from the micro display chip and passing through the auxiliary optical imaging system, after being reflected by the semi-reflective, semi-transmissive layer, generates a specific phase modulation. On one hand, the light is reflected into the human eye; on the other hand, the phase modulation produces a virtual image located outside the optical element.

The phase compensation layer compensates for the phase changes in the phase modulation layer, ensuring that the light passing through the optical element experiences no phase modulation and enters the eye without interference. The optical function of this optical element is to be both transparent and capable of forming an image. It has no effect on the light from the external world, remaining essentially transparent, while it can form a virtual image for the light from the micro display chip.

The head-up display system disclosed in this patent is characterized by further including other optical imaging systems, such as spherical mirrors, reflectors, aspherical lenses, and freeform surfaces, which work in conjunction with the transparent optical element. The light emitted by the micro display and magnified by the auxiliary optical imaging system forms a virtual image displayed outside the optical element. These optical elements also function to fold the optical path, making the volume of the optical system, except for the final optical element, as small as possible, allowing it to be installed under the vehicle dashboard, thus making it adaptable to a wider range of vehicle models. The auxiliary optical imaging system can be included, but when the light emitted by the micro display directly forms a virtual image through the transparent optical element, the auxiliary optical imaging system is not necessary.

The transparent optical element has a planar or nearly planar structure. Furthermore, the shape of the transparent optical element is either flat or sufficiently close to a flat structure. For example, if the curvature of the transparent optical element is sufficiently small, it can be installed on the vehicle's windshield. In another embodiment of this patent, the curvature of the vehicle glass is integrated into the overall curvature of the system.

Since this element is transparent to the light from the external world, it can be directly integrated into the windshield without affecting the driver's normal usage. The distinctive feature of this head-up display system is that the final transparent optical element is integrated into the windshield. By utilizing the existing space in the windshield and dashboard, only part of the optical system needs to be integrated under the dashboard. The size of the optical system under the dashboard will be the only factor affecting the installation of the head-up display, greatly reducing the space required for the optical components. This makes the head-up display system suitable for use in vehicles of various sizes.

He phase modulation surface is also coated with a semi-reflective, semi-transmissive layer. The semi-reflective, semi-transmissive layer refers to a surface where part of the light incident upon it is reflected, while part of the light is transmitted. Its reflectance (R) and transmittance (T) can be anywhere in the range from 0% to 100%. The semi-reflective, semi-transmissive layer can be achieved using a metallic reflective film, or by creating a refractive index gradient with a high refractive index material.

In one embodiment of the present invention, the semi-reflective, semi-transmissive layer exhibits polarization selectivity, reflecting light of a specific polarization state while transmitting light of another polarization state. In this embodiment, the light emitted by the micro display chip is also set to this specific polarization state, so the light emitted by the micro display chip can be reflected with a high reflectance into the human eye, enhancing the display's luminous efficiency while maintaining a high transmittance.

In another embodiment of the present invention, the light emitted by the micro display chip is narrowband light in the red, green, and blue wavelengths. The reflection wavelength range of the medium reflective layer of the semi-reflective layer is closely matched with the emission wavelength range of the micro display chip, so that most of the light emitted from the micro display chip is reflected into the eye, improving the luminous efficiency of the display while maintaining a high transmittance.

In another embodiment of this patent, the semi-reflective, semi-transmissive layer further includes an opto-electrical or opto-optical device, whose reflectance and transmittance can be adjusted to adapt to different lighting conditions. The opto-electrical device can be various types of liquid crystal, electrochromic, electrophoretic devices, etc. The opto-optical device can be various types of photochromic devices.

The phase compensation layer works in close cooperation with the phase modulation layer, with their phases being exactly opposite and compensating for each other. For the light that passes through, the two layers cancel each other out, having no effect, ensuring that the external image is not affected and reaches the human eye, forming a transparent display. The manufacturing process of the phase compensation layer can involve various known optical processing methods, where the phase modulation layer and the phase compensation layer are separately processed and then bonded together using optical adhesive. Alternatively, after the phase modulation layer is formed, a flexible optical material can be directly applied on it, then cured to automatically form the phase compensation layer.

The present invention discloses a vehicle head-up display system, where a transparent optical element that forms a virtual image is installed on the windshield, achieving a large field of view and a compact size head-up display. Its advantages are as follows:
1) Large field of view and display area, allowing more content to be displayed.
2) The curvature of the transparent optical element is sufficiently small, and it has no effect on the transmitted light, allowing it to be installed on the vehicle's front windshield, making full use of the existing space.
3) The compact size of the system under the dashboard allows it to be adapted to a wider range of vehicle models.

### DESCRIPTION OF THE DRAWINGS

FIG. 1(a) is a schematic diagram of an embodiment of the present invention;

and FIG. 1(b) is a schematic diagram of an embodiment of the present invention, showing the virtual image.

FIG. 2(a) is a schematic diagram of a structure of the transparent optical element, where the phase structure is a holographic structure.

FIG. 2(b) is a schematic diagram of a structure of the transparent optical element, where the phase structure is a holographic structure.

FIG. 3 is a schematic diagram of a structure of the transparent optical element, where the phase structure is a Fresnel surface shape.

FIG. 4 is a schematic diagram of a structure of the transparent optical element, where the phase structure is a binary optical surface shape.

FIG. 5 is a schematic diagram of a structure of the transparent optical element, where the phase structure is a holographic surface shape.

FIG. 6 is an example of a holographic phase modulation layer generated by a computer.

### DETAILED DESCRIPTION OF THE EMBODIMENTS

In order to make the objectives, technical solutions, and advantages of the present invention clearer and more explicit, the following detailed description of the invention is provided with reference to the accompanying drawings and through the use of specific embodiments. It should be understood that the specific embodiments described here are intended to explain the present invention and are not intended to limit the scope of the invention.

### First Embodiment

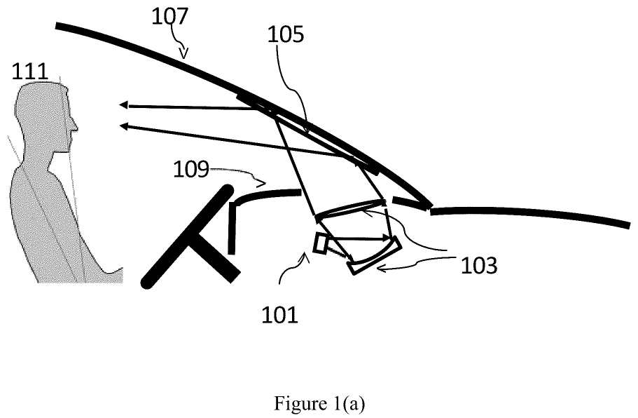

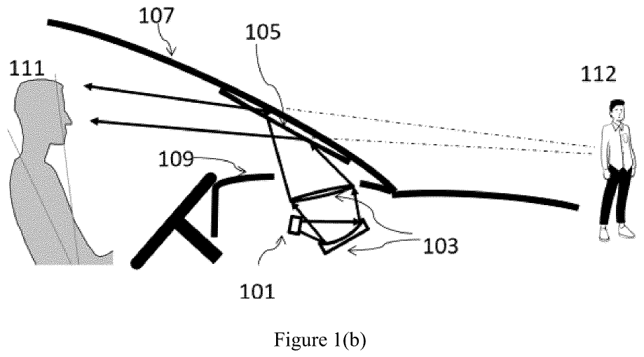

The first embodiment of the present invention is shown in FIGS. 1(a) and 1(b). This embodiment takes automobiles as an example to illustrate the application of the present invention. Engineers in the industry can apply the concept of this embodiment to various other vehicles and transportation tools (such as aviation, etc.), where a virtual image integrated with the real world can be generated, which still falls within the scope of the present invention.

The micro-display chip (micro display screen) 101 generates a high-brightness small image. This image is magnified into a virtual image 112 for the driver (mainly referring to the driver's eyes) 111 by the auxiliary optical imaging element 103 and the transparent optical element 105. The humanoid virtual image 112 shown in FIG. 1 is just an example; the core idea is to magnify the image generated by the micro-display chip into a virtual image, and is not limited to the virtual image being humanoid.

The transparent optical element 105 has a flat or nearly flat structure. Further, the shape of the transparent optical element 105 can be flat or sufficiently close to a flat structure. The curvature of the transparent optical element 105 can be small enough, while remaining transparent to the external world's images, allowing it to be integrated into the windshield 107. Information about driving or entertainment can be displayed on the road surface. The transparent optical element 105 is presented as a structure with extremely small thickness, and the curvature can be small enough to resemble a flat structure. This transparent optical element 105 can be mounted in front of the windshield 107 using a separate structure such as a bracket, or it can be applied directly to the windshield 107. When the transparent optical element 105 is pre-purchased by the automobile manufacturer, the curvature of the windshield 107 can be adapted to that of the transparent optical element 105, allowing it to be directly integrated into the existing windshield 107. The placement of the transparent optical element 105 is primarily designed so that the driver can see the displayed information without having to look down while driving. This design greatly enhances driving safety and comfort. Unlike traditional automobile head-up displays, the transparent optical element 105 in this patent is mounted on the windshield 107 of the vehicle, utilizing the large space between the instrument panel 109 and the windshield 107. This reduces the space needed to be installed within the vehicle body below the instrument panel 109, making the head-up display suitable for various vehicle models.

The micro-display chip (micro display screen) 101 can be any of the common micro-display technologies such as LCD, LED, LCOS, DLP, OLED, Micro-LED, or eInk electronic paper. In order to generate a high-brightness image, it may also include related components such as a light source, diffuser, electronic controller, communication module, heat dissipation module, etc. The different types of micro-display chips do not fall outside the scope of the present patent.

To further improve image quality, one or more auxiliary optical imaging lenses (or auxiliary optical imaging systems) 103 can be added to the micro-display chip. These may include mirrors to adjust the light path direction, fold the light path for a smaller volume, and lenses, prisms, aspherical mirrors, freeform mirrors, or other optical components known to industry engineers. The combination of these different components does not fall outside the scope of the present invention.

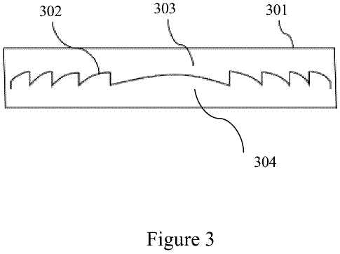

An enlarged view of the transparent optical element 105 is shown in FIG. 3, which includes a phase modulation surface 302, a semi-reflective and semi-transmissive layer 303, and a phase compensation layer 304. The phase modulation layer, in conjunction with the semi-reflective and semi-transmissive layer, controls the light emitted by the micro-display chip 101 and magnified by the auxiliary imaging optical system 103, reflecting it into the human eye, while making the light from the optical system form a virtual image in the distance. The semi-reflective and semi-transmissive layer 303 allows part of the light from the real world to pass through.

The phase compensation layer 304 compensates for the phase changes in the phase modulation layer 302, ensuring that the phase disturbance of the light passing through the transparent optical element 105 is minimized. Without phase modulation, the light enters the eye without interference, effectively acting as a transparent optical plate. The optical function of this optical component is both transparent and capable of forming an image. It has no effect on the light from the external world and remains nearly transparent, while forming a virtual image of the light emitted by the optical system below the instrument panel 109.

Specifically, the phase modulation layer 302 can be equipped with the semi-reflective and semi-transmissive layer 303. The light emitted from the micro-display chip 101 directly enters the semi-reflective and semi-transmissive layer 303, or enters it after passing through the auxiliary optical imaging system 103. After being reflected by the semi-reflective and semi-transmissive layer, the light undergoes a set phase modulation. On one hand, it is reflected into the human eye, creating a virtual image located in the opposite direction from the optical element and the human eye. The phase compensation layer compensates for the phase changes in the phase modulation layer, ensuring that the light passing through the optical element reaches the human eye without phase modulation, entering without interference.

From another perspective, the light path is designed so that the light emitted from the micro-display chip 101 passes through the auxiliary optical imaging system 103 and enters the semi-reflective and semi-transmissive layer 303. After reflection from this layer, the light undergoes phase modulation, which is reflected into the human eye. The phase modulation creates a virtual image located in the opposite direction from the optical element and the human eye. The phase compensation layer compensates for the phase changes in the phase modulation layer, allowing the light passing through the optical element to enter the human eye without interference. This transparent and image-forming optical element achieves a large field of view visual effect, and the compact design of the light path and optical components allows them to be installed in the available spaces between the windshield and instrument panel, enabling compatibility with a wide range of vehicle models. The curvature of the transparent optical element 105 is sufficiently small, and it is transparent to the external image. It can be integrated into the windshield 107, displaying driving or entertainment information on the road surface. This allows the driver to see the displayed information without having to lower their head while driving, greatly enhancing driving safety and comfort. Unlike traditional vehicle head-up displays, one side of the transparent optical element 105 in this patent is installed on the vehicle's windshield 107, utilizing the ample space between the instrument panel 109 and the windshield 107. This reduces the space required for installation beneath the instrument panel 109, enabling the head-up display to be compatible with various vehicle models.

The following provides a detailed explanation of the principle of the transparent optical element, with several examples to illustrate its function. The first core aspect of the transparent optical element is that the phase compensation layer compensates for the phase variations caused by the phase modulation layer, ensuring that light passing through the optical element experiences no phase modulation and enters the human eye without interference. This can be achieved in the following ways:
1) The phase modulation layer can have nano- or micrometer-scale phase modulation structures;
2) The phase compensation layer can have nano- or micrometer-scale phase compensation structures that counteract the phase changes induced by the phase modulation layer;
3) A partially transparent and reflective layer between the phase modulation layer and the phase compensation layer, which partially reflects light while allowing some light to pass through.

This structure can be repeated multiple times to form a multilayer structure (from layers 1, 2 to i-1, i). Different light rays (from a, b, . . . z, please note that the English letters are used only to represent different light rays and are not limited to 26) pass through the optical film at different positions and angles.

In optics, optical path length (OPL) or optical distance is the product of the geometric length of the light path (L1, L2, to Li) through the system and the refractive index (n) of the medium it passes through (OPL=L×n). The difference in optical path length between two paths is typically referred to as optical path difference (OPD). Optical path length is important because it determines the phase of light and controls interference and diffraction as light propagates. The optical path length between the phase modulation layer and the phase compensation layer is OPD1. The phase modulation layer and phase compensation layer have opposite optical phases, so they compensate for each other. The total optical path length for all rays (a, b, . . . z) passing through the entire film is a constant C.

$$O {\sum }^{n} PDi = C$$

Where C is a constant; OPDi is the phase modulation of each optical structure, with i representing different optical layers, and i=1 to n.

Due to the numerous design degrees of freedom in multi-layer phase structures, this phase structure can achieve complex optical functions to meet various imaging needs.

The optical manufacturing process of the phase modulation structure includes, but is not limited to, methods such as optical etching, optical lithography, nano-molding, and nano-imprinting. After the light passing through the transparent optical element is reflected by the semi-reflective layer, a predetermined phase modulation is generated. This phase modulation also creates a virtual image relative to the position opposite the optical element with respect to the human eye.

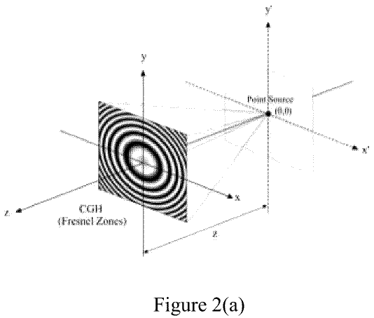

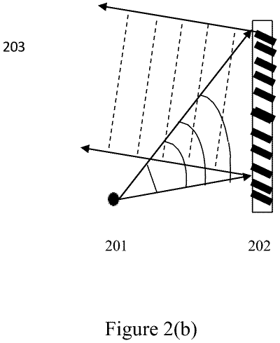

The phase modulation structure in the above transparent optical element 105 is further illustrated in FIGS. 2, 3, 4, and 5. In one embodiment (as shown in FIG. 2), the phase structure can be implemented in various ways, including but not limited to scattering surface relief structures, various grating structures, and computer-generated holography (CGH), etc. In one embodiment, the surface relief structure can be replicated from a holographic master. The phase modulation layer is a CGH structure, as shown in FIGS. 2(a) and (b). As an example, the CGH structure can be designed using a computational method based on the concept of point light sources, where the object is decomposed into spontaneous light points in FIG. 2(a). The basic hologram for each point source is computed, and the final hologram is synthesized by superimposing all the basic holograms. Light from the microdisplay chip is reflected in a certain direction to form a virtual image.

After reading the remainder of the specification, those skilled in the art will have a better understanding of the features of these embodiments as well as other embodiments. Different phase modulation layers exist, which can redirect light to different directions with varying angular distributions. These variations are within the scope of the techniques and methods disclosed in this invention.

In a specific embodiment of the transparent optical element of the present invention, the embodiment shown in FIG. 3 employs a Fresnel surface type. It includes a phase modulation layer 302, the surface of which is coated with a semi-transmissive/reflective layer 303, and a phase compensation layer 304 that works in conjunction with the phase modulation layer.

The phase modulation layer 302 can be an improved Fresnel lens, such as a thin Fresnel lens with a lens surface. The surface profile of the Fresnel lens 302 can be derived from a spherical, aspherical, or freeform surface, or from a hologram. This surface profile design is generated by optical design software and, in combination with other optical components in the system, produces an enlarged virtual image of the image generated by the microdisplay chip.

The phase compensation layer 304 and the phase modulation layer 302 are closely coupled together. For the transmitted light, their phases mutually cancel each other out, having no effect, allowing external images to reach the human eye without being affected, thus forming a transparent display.

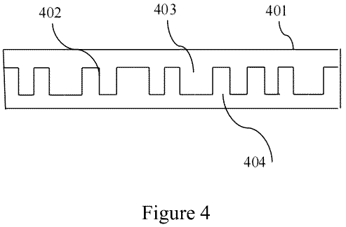

FIG. 4 shows another implementation of the transparent optical element 401, which uses a binary optical structure. It includes a phase modulation layer 402 of a binary optical structure designed by computer, with a unique surface profile, a semi-reflective/transparent metal coating, a polarizing film, or an optical dielectric film 403, and a phase compensation layer 404. The phase modulation layer 402 is designed to produce an enlarged virtual image from the light emitted by the microdisplay chip 101 and magnified by the auxiliary optical imaging system 103. The processing of the modulation surface can be carried out using nano-imprinting, where a specific surface shape is formed on a mold under computer control, and then transferred onto the optical substrate through nano-imprinting.

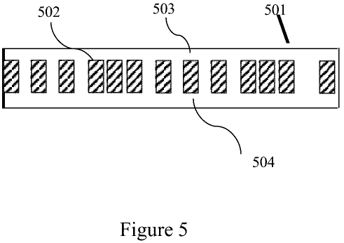

FIG. 5 shows another implementation of the transparent optical element 501, which uses a holographic optical structure. It includes a holographic phase modulation layer 502 designed by computer, with a unique surface profile, a semi-reflective/transparent metal coating or optical dielectric film 503, and a phase compensation layer 504. The phase modulation layer 502 is designed to produce an enlarged virtual image from the light emitted by the microdisplay chip 101 and magnified by the auxiliary optical imaging system 103. The processing of the modulation surface can be carried out using nano-imprinting, where a specific surface shape is formed on a mold under computer control, and then transferred onto the optical substrate through nano-imprinting. Alternatively, coherent light can be used to record the surface pattern on the optical substrate.

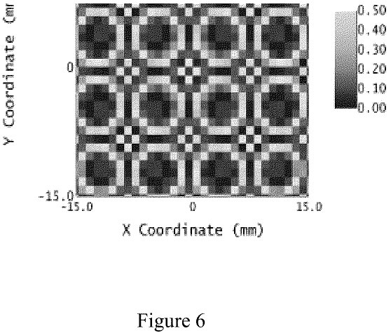

FIG. 6 is an example of a holographic phase modulation layer generated by a computer.

In an embodiment of the present invention, a semi-reflective/transparent layer is also coated on the phase modulation surface. The semi-reflective/transparent layer refers to a layer where part of the light incident on its surface is reflected, and part is transmitted. Its reflectance (R) and transmittance (T) can range from 0% to 100%, within any interval. The semi-reflective layer can be realized using a metallic reflective film or by forming a refractive index gradient using a high refractive index material.

In one embodiment of the present invention, the semi-reflective/transparent layer has polarization selectivity, reflecting light of a particular polarization state while transmitting light of another polarization state. In this embodiment, the light emitted by the microdisplay chip is also set to this polarization state, so the light emitted by the microdisplay chip can be reflected into the human eye with a high reflectance, improving the display's luminous efficiency while maintaining a high transmittance.

In another embodiment of the present invention, the light emitted by the microdisplay chip consists of narrowband red, green, and blue light. The reflective wavelength range of the dielectric layer in the semi-reflective layer is closely matched with the wavelength range of the light emitted by the microdisplay chip, so most of the light emitted by the microdisplay chip is reflected back into the eye, improving the display's luminous efficiency while maintaining a high transmittance.

In another embodiment of the present invention, the semi-reflective/transparent layer further includes an optoelectronic or opto-optic device whose reflectance and transmittance can be adjusted to suit different ambient lighting conditions. The optoelectronic device can be various types of liquid crystal, electrochromic, electrophoretic devices, etc. The opto-optic device can be various types of photochromic devices.

The phase compensation layer described above works in close coordination with the phase modulation layer, with their phases being exactly opposite, compensating each other. For transmitted light, the two layers cancel each other out and have no effect, allowing external images to reach the human eye unaffected, thus forming a transparent display. The processing method for the phase compensation layer can involve various well-known optical fabrication techniques, where the phase modulation layer and phase compensation layer are separately processed and then bonded together using optical adhesive. Alternatively, after the phase modulation layer is processed and shaped, a flexible optical material can be directly filled on top of it and then cured to automatically form the phase compensation layer.

### Second Example

In this embodiment of the present invention, the auxiliary optical element 103 is an optional device that further reduces the system's volume. For example, the microdisplay chip and the transparent optical element can be directly integrated to form the optical path. The phase modulation layer is provided with the semi-reflective/transparent layer, through which light emitted from the microdisplay chip directly enters. After being reflected by the semi-reflective/transparent layer, the light undergoes a predetermined phase modulation. This light is reflected toward the human eye, while the phase modulation also generates a virtual image relative to the position opposite the optical element and the human eye. The phase compensation layer compensates for the phase changes of the phase modulation layer, ensuring that light passing through the optical element remains unaffected by phase modulation and enters the human eye without interference.

In summary, the present invention provides a compact, wide-angle head-up display (HUD) system, including: a microdisplay chip (microdisplay screen), an auxiliary optical imaging system, and a transparent optical element. The microdisplay chip generates a display image, the auxiliary optical imaging system magnifies the image from the microdisplay chip, and the transparent optical element further magnifies the light magnified by other optical systems into a virtual image. The reflective optical element includes phase modulation and phase compensation layers, which cancel each other out for transmitted light, having no effect, allowing external images to reach the human eye unaffected, thus forming a transparent display. Unlike traditional automotive HUD systems, the transparent optical element is mounted on the car's windshield, utilizing the space between the dashboard and the windshield. This reduces the space that needs to be installed below the dashboard in the vehicle, making the head-up display suitable for various car models.

It should be understood that the system application of the present invention is not limited to the above example. Those skilled in the art can make improvements or modifications based on the above description, and all such improvements and modifications should fall within the scope of the claims of the present invention.

We claim:

1. A compact, wide-field-of-view head-up display system, comprising: 1) a microdisplay chip; 2) a transparent optical element positioned at a certain distance from the display chip, which forms a virtual image;
wherein the optical element further includes a semi-reflective/transparent layer, a phase modulation layer, and a phase compensation layer;
wherein the phase modulation layer controls the light from the microdisplay chip, reflecting it to the human eye, so that the light forms an enlarged virtual image at a distance;
wherein the semi-reflective/transparent layer allows a portion of light from the real world to pass through;
wherein the transparent optical element has a planar shape is sufficiently close to a planar shape.

2. The compact, wide-field-of-view head-up display system according to claim 1, wherein it further includes an auxiliary optical imaging system, wherein the light emitted from the microdisplay chip is processed by the auxiliary optical imaging system before entering the transparent optical element.

3. The compact, wide-field-of-view head-up display system according to claim 1, wherein the phase modulation layer controls the light from the microdisplay chip, reflecting it to the human eye, so that the light forms an enlarged virtual image at a distance; wherein the semi-reflective/transparent layer also allows a portion of light from the real world to pass through:
further comprise the phase modulation layer having a semi-reflective/transparent layer, through which light emitted from the microdisplay chip directly enters the semi-reflective/transparent layer, or enters the semi-reflective/transparent layer after being processed by the auxiliary optical imaging system; after reflection by the semi-reflective/transparent layer, the light undergoes the desired phase modulation, reflecting toward the human eye and generating a virtual image relative to the position opposite the optical element and the human eye; the phase compensation layer compensates for the phase change of the phase modulation layer, ensuring that light passing through the optical element remains unaffected by phase modulation and enters the human eye without interference.

4. The compact, wide-field-of-view head-up display system according to claim 1, wherein the microdisplay chip is one of the following microdisplay technologies: LCOS, LCD, DLP, OLED, LED, Micro-LED.

5. The compact, wide-field-of-view head-up display system according to claim 1, wherein the transparent optical element is integrated into the vehicle's windshield.

6. The compact, wide-field-of-view head-up display system according to claim 1, wherein it further includes another optical imaging system;
wherein the other optical system consists of spherical mirrors, reflective mirrors, aspherical lenses, or freeform surfaces, and is used in conjunction with the transparent optical element.

7. The compact, wide-field-of-view head-up display system according to claim 1, wherein the phase modulation surface is a holographic structure, and the holographic structure generates an enlarged virtual image from the image produced by the microdisplay chip.

8. The compact, wide-field-of-view head-up display system according to claim 1, wherein the phase modulation surface is a Fresnel lens with a thin structure, and the phase modulation produced by the Fresnel lens is a spherical mirror, generating an enlarged virtual image from the image produced by the microdisplay chip.

9. The compact, wide-field-of-view head-up display system according to claim 1, wherein the phase modulation surface is a Fresnel lens with a thin structure and a lens shape, and the phase modulation produced by the Fresnel lens is an aspherical mirror, generating an enlarged virtual image from the image produced by the microdisplay chip.

10. The compact, wide-field-of-view head-up display system according to claim 1, wherein the phase modulation surface is a Fresnel lens with a thin structure and a lens shape, and the phase modulation produced by the Fresnel lens is a freeform mirror, generating an enlarged virtual image from the image produced by the microdisplay chip.

11. The compact, wide-field-of-view head-up display system according to claim 1, wherein the semi-reflective layer is a metal semi-reflective layer.

12. The compact, wide-field-of-view head-up display system according to claim 1, wherein the semi-reflective layer is a dielectric reflective layer.

13. The compact, wide-field-of-view head-up display system according to claim 1, wherein the reflection wavelength range of the dielectric reflective layer of the semi-reflective layer is close to the emission wavelength range of the microdisplay chip, such that most of the light emitted from the microdisplay chip is reflected into the eye.

14. The compact, wide-field-of-view head-up display system according to claim 1, wherein the light emitted from the microdisplay chip has a specific polarization state, and the reflected light from the semi-reflective layer is also controlled in this polarization state, such that most of the light emitted from the microdisplay chip is reflected into the eye.

15. The compact, wide-field-of-view head-up display system according to claim 1, wherein the reflectance and transmittance of the semi-reflective layer are configured to be adjustable, to adapt to different environmental lighting conditions.
